(19) United States
(12) Patent Application Publication
(10) Pub. No.: US 2016/0273691 A1
(43) Pub. Date: Sep. 22, 2016

(54) HOSE CLIP AND MANUFACTURING PROCESS THEREOF

(71) Applicant: HYUNDAI MOTOR COMPANY, Seoul (KR)

(72) Inventors: In Hwan OH, Seoul (KR); Sang Soo KIM, Anyang-si (KR)

(73) Assignee: HYUNDAI MOTOR COMPANY, Seoul (KR)

(21) Appl. No.: 14/822,702

(22) Filed: Aug. 10, 2015

(30) Foreign Application Priority Data
Mar. 20, 2015 (KR) 10-2015-0038858

(51) Int. Cl. F16L 31/00; F16L 25/06; F16L 58/04; F16L 58/18; C25F 1/00; F16L 25/00; F16L 37/05

(52) U.S. Cl. CPC F16L 31/00; F16L 25/0018; F16L 25/06; F16L 37/05; F16L 58/18; C25F 1/00; F16L 58/04

(57) ABSTRACT

A hose clip includes a body made of a steel material, and a composite coating film formed on a surface of the body. The composite coating film is clear post-processed with a silicate-based material so that a silicate inorganic binder and an acrylic inorganic binder are appropriately diluted in the hose clip to perform clear post-processing coating, thereby preventing corrosion by potential difference and improving visibility. Phenomenon such as coolant leakage and engine burning due to fastening omission of the hose clip may be prevented to improve marketability and durability of a vehicle, and a manufacturing process of the hose clip.

### CROSS-REFERENCE TO RELATED APPLICATION

This application is based on and claims the benefit of priority to Korean Patent Application No. 10-2015-0038858, filed on Mar. 20, 2015 in the Korean Intellectual Property Office, the disclosure of which is incorporated herein in its entirety by reference.

### TECHNICAL FIELD

The present disclosure relates to a hose clip and a manufacturing process thereof, and specifically, to a hose clip preventing occurrence of phenomenon such as coolant leakage and engine burning due to fastening omission of a hose clip during vehicle assembly, and a manufacturing process thereof.

### BACKGROUND

In general, a hose clip 1 is a component connecting a rubber hose 2 and a pipe mounted in a vehicle as shown in FIG. 1 and preventing oil leak such as engine oil, coolant, brake oil, and the like.

In the existing hose clip 1, surface treatment is mainly performed by black post-processing or clear post-processing on a zinc-aluminum composite coating film as shown in FIGS. 2A and 2B.

Here, in a case of a black post-processed zinc-aluminum composite coating film as shown in FIG. 2A, corrosion resistance is excellent, and problems due to corrosion (decrease in appearance due to surface corrosion, damage due to decrease in a material thickness) are no serious. However, since a color of the black pose-processed zinc-aluminum composite coating film is the same as that of the rubber hose 2, fastening of the hose clip 1 may be omitted.

In addition, in a case of a clear post-processed zinc-aluminum composite coating film as shown in FIG. 2B, since the clear post-processed zinc-aluminum composite coating film passes through silver which is an original color of the composite coating film, a color of the clear post-processed zinc-aluminum composite coating film is different from that of the rubber hose 2, such that the problem of fastening omission may be reduced. However, due to potential corrosion between the hose clip 1 and the rubber hose 2, corrosion resistance is inferior as compared to the black post-processed zinc-aluminum composite coating film, and therefore, at the time of processing vehicle durability, corrosion may occur.

That is, since the existing hose clip has a black color which is the same as that of the rubber hose, it is difficult to distinguish defects during vehicle assembly, which causes fastening omission of the hose clip, and eventually, problems such as coolant leakage and engine burning occur.

### RELATED ART DOCUMENT

(Patent Document 1) Japanese Patent Laid-Open Publication No. 2006-083464

### SUMMARY

The present disclosure has been made to solve the above-mentioned problems occurring in the prior art while advantages achieved by the prior art are maintained intact.

An aspect of the present disclosure provides a hose clip and a manufacturing process thereof, specifically, a hose clip preventing occurrence of phenomenon such as coolant leakage and engine burning due to fastening omission of a hose clip during vehicle assembly, and a manufacturing process thereof.

According to an exemplary embodiment of the present disclosure, there is provided a hose clip incluidng a body made of a steel material and a composite coating film formed on a surface of the body. The composite coating film may be clear post-processed with a silicate-based material to improve visibility and to secure corrosion resistance when coupling with a rubber hose.

The silicate-based material may include a water-soluble inorganic main component of alkaline silicate.

The body may be post-processed with the water-soluble inorganic main component to prevent corrosion by potential difference of the rubber hose.

The silicate-based material may be stacked and coated at a thickness of 2 to 4 μm.

The silicate-based material may consist of a silicate inorganic binder in an amount of 70 to 80% and an acrylic inorganic binder in an amount of 20 to 30%.

According to another exemplary embodiment of the present disclosure, a manufacturing process of a hose clip includes: a composite coating film deposition-coating step of performing deposition-coating with a composite coating film on a hose clip; a desulfurization step of performing desulfurization, after the composite coating film deposition-coating step; a desulfurization and dryness step of performing desulfurization and dryness, after performing the desulfurization step and deposition-coating again with a composite coating film on the hose clip; and a silicate-coating step of performing clear coating with a silicate-based material on the hose clip, after the desulfurization and dryness step.

The manufacturing process may further include: a deposition-degreasing step of removing deposition on a surface of the hose clip; a pickling treatment step of removing an oxide film on the surface of the hose clip after the deposition-degreasing step; an electrolytic degreasing step of removing an oil membrane attached onto the surface of the hose clip by using gas generated in electrolysis after the pickling treatment step; and a shot pinning step of spraying a shot on the surface of the hose clip to generate residual pressure stress on a surface layer and to intensify the hose clip by work hardening after the electrolytic degreasing step, wherein after the shot pinning step, the composite coating film deposition-coating step is performed.

The composite coating film deposition-coating step may include a first composite coating film deposition-coating step and a second composite coating film deposition-coating step, and the desulfurization step may include a first desulfurization step and a second desulfurization step, and the desulfurization and dryness step may include a first desulfurization and dryness step and a second desulfurization and dryness step, and the silicate-coating step may include a first silicate-coating step and a second silicate-coating step.

After the shot pinning step, the first composite coating film deposition-coating step of performing deposition-coating with the composite coating film on the hose clip may be performed, after the first composite coating film deposition-coating step, desulfurization may be performed by the first desulfurization step, after the first desulfurization step, deposition-coating with a composite coating film on the hose clip may be performed again by the second composite coating film deposition-coating step, after the second composite coating film deposition-coating step, desulfurization and dryness may be performed by the first desulfurization and dryness step, after the first desulfurization and dryness step, clear coating with a silicate-based material on the hose clip may be performed by the first silicate-coating step, after the first silicate-coating step, desulfurization may be performed by the second desulfurization step, after the second desulfurization step, clear coating with a silicate-based material on the hose clip may be performed again by the second silicate-coating step, and after the second silicate-coating step, desulfurization and dryness may be performed by the second desulfurization and dryness step.

The composite coating films in the first composite coating film deposition-coating step and the second composite coating film deposition-coating step may be a zinc-aluminum composite coating film.

According to still another exemplary embodiment of the present disclosure, a hose clip for coupling with a rubber hose may include a body made of a steel material, and a composite coating film coated on a surface of the body. The composite coating film may include a silicate-based material.

The silicate-based material may include a water-soluble inorganic main component of alkaline silicate.

The silicate-based material may be stacked and coated at a thickness of 2 to 4 μm.

The silicate-based material may consist of a silicate inorganic binder in an amount of 70 to 80% and an acrylic inorganic binder in an amount of 20 to 30%.

A color of the hose clip may be different from a color of the rubber hose.

### BRIEF DESCRIPTION OF THE DRAWINGS

The above and other objects, features and advantages of the present disclosure will be more apparent from the following detailed description taken in conjunction with the accompanying drawings.

FIG. 1 illustrates a state in which a hose clip is mounted on a rubber hose.

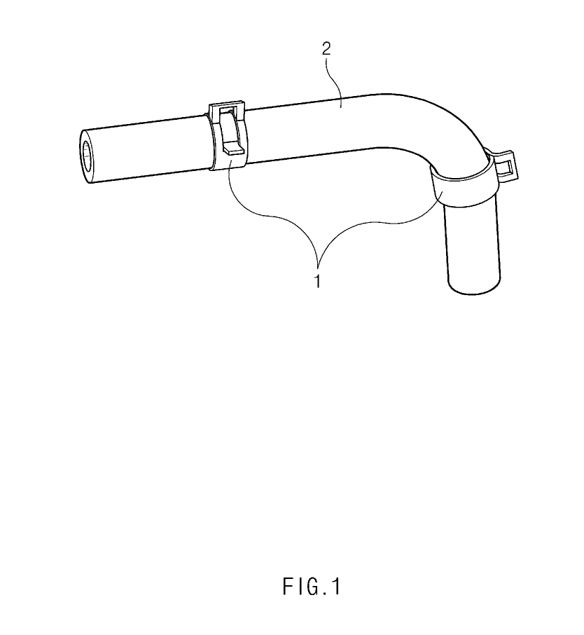

FIGS. 2A and 2B illustrate a state of the existing hose clip.

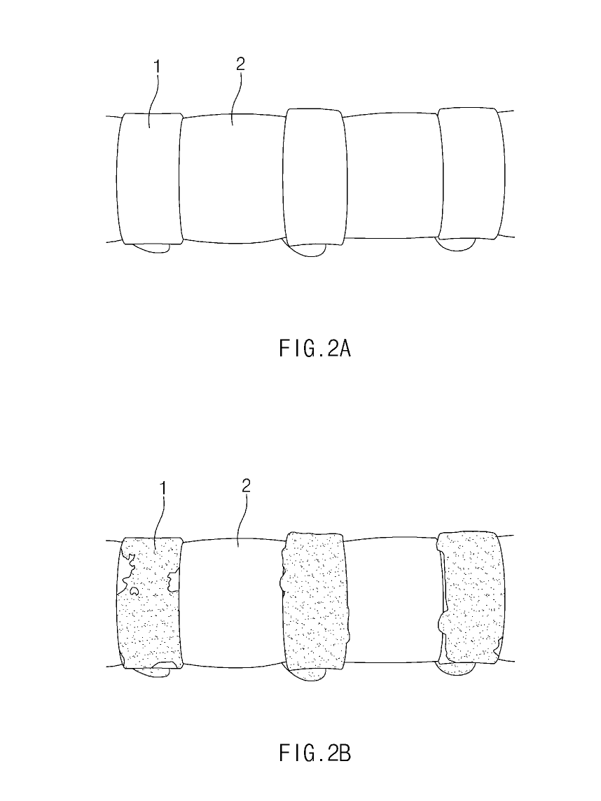

FIG. 3 shows a hose clip according to the present disclosure.

FIGS. 4A and 4B illustrate a state in which the hose clip according to the present disclosure is mounted on a rubber hose.

FIG. 5 illustrates comparison between the hose clip according to the present disclosure and the existing hose clip.

FIG. 6 is a flow chart illustrating a manufacturing process of the hose clip according to the present disclosure.

### DETAILED DESCRIPTION

Exemplary embodiments of the present disclosure will be described in detail with reference to the accompanying drawings.

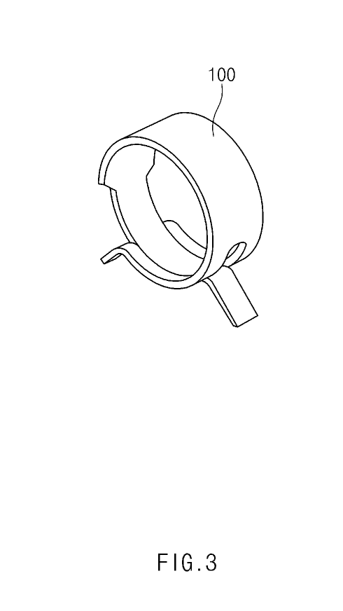

A hose clip according to the present disclosure is characterized by performing a clear post-processing with a silicate-based material on a surface of a body 100 as shown in FIGS. 3 to 5.

Here, the body 100 of the hose clip is made of a steel material, and a composite coating film is formed on a surface of the body.

Meanwhile, the body 100 may be applied to various components made of the steel material. Hereinafter, a hose clip among various components will be described as one exemplary embodiment in the present disclosure.

By performing clear post-processing with a silicate-based material on a composite coating film on the surface of the body 100, visibility with the hose clip and the rubber hose 110 may be improved and corrosion resistance occurring in the hose clip may be secured.

Here, as the silicate-based material which is the composite coating film forming the surface of the body 100, a water-soluble surface treatment agent which is an inorganic main component of alkaline silicate is preferably applied.

In addition, it is preferred that the surface of the body 100 is post-processed with the water-soluble surface treatment agent which is the inorganic main component to prevent corrosion by potential difference between the hose clip and the rubber hose 110.

Here, the silicate-based material may be stacked and coated at a thickness of 2 to 4 μm to improve corrosion resistance.

Meanwhile, as an amount of the silicate-based material is increased, electric corrosion with the rubber hose 110 may be favorably prevented; however, whitening phenomenon may occur in the hose clip. Therefore, the silicate-based material preferably consists of a silicate inorganic binder in an amount of 70 to 80% and an acrylic inorganic binder in an amount of 20 to 30% to improve corrosion resistance and prevent whitening phenomenon.

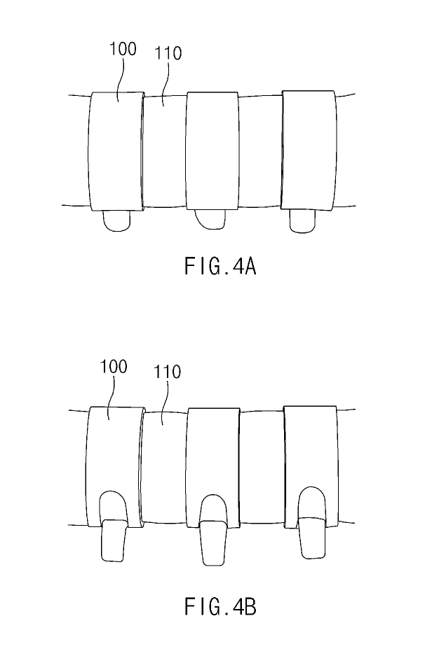

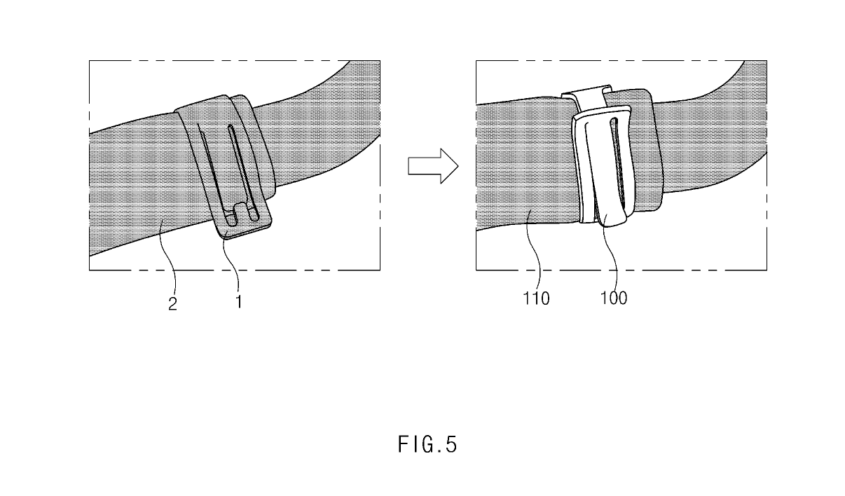

As described above, according to the present disclosure, the composite coating film is formed on the surface of the body 100 made of a steel material, and the composite coating film is clear post-processed with the silicate-based material so that the silicate inorganic binder and the acrylic inorganic binder are appropriately diluted in the hose clip as shown in FIGS. 3, 4A, and 4B to perform clear post-processing coating as shown in FIG. 5, thereby preventing corrosion by potential difference, improving visibility as compared to the related art. Therefore, phenomenon such as coolant leakage and engine burning due to fastening omission of the hose clip may be prevented to improve marketability and durability of a vehicle.

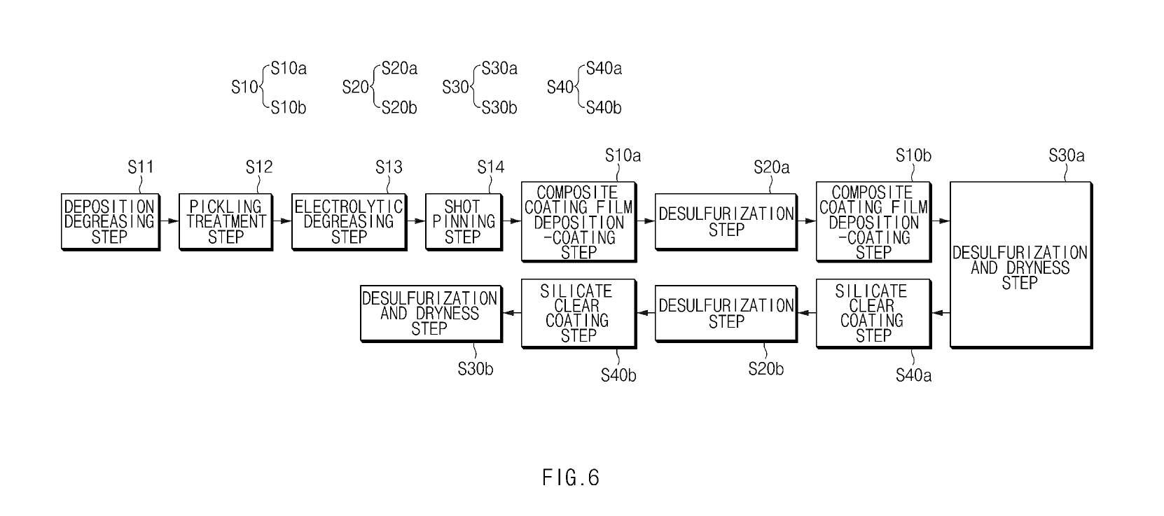

In addition, a manufacturing process of the hose clip according to the present disclosure includes a composite coating film deposition-coating step S10 of performing deposition-coating on a hose clip, a desulfurization step S20 of performing desulfurization, a desulfurization and dryness step S30 of performing desulfurization and dryness after performing the deposition-coating step, and a silicate-coating step S40 of performing clear coating with a silicate-based material as shown in FIG. 6.

In the composite coating film deposition-coating step S10, deposition-coating is performed by using the composite coating film on the hose clip.

Here, before performing the composite coating film deposition-coating step S10, a step of removing deposition, an oxide film, and a glass film from the surface of the hose clip, and a step of intensifying the hose clip by work hardening are required to be performed.

A deposition-degreasing step S11 is to remove deposition on the surface of the hose clip.

A pickling treatment step S12 is to remove an oxide film on the surface of the hose clip after the deposition-degreasing step S11.

An electrolytic degreasing step S13 is to remove an oil membrane attached onto the surface of the hose clip by using gas generated in electrolysis after the pickling treatment step S12.

A shot pinning step S14 is to spray a shot on the surface of the hose clip to generate residual pressure stress on a surface layer and is to intensify the hose clip by work hardening after the electrolytic degreasing step S13.

After the shot pinning step S14, the composite coating film deposition-coating step S10 of performing deposition-coating by using the composite coating film on the hose clip is performed.

The desulfurization step S20 is to perform desulfurization after the composite coating film deposition-coating S10.

The desulfurization and dryness step S30 is to perform deposition-coating with the composite coating film on the hose clip again and then perform desulfurization and dryness after the desulfurization step S20.

The silicate-coating step S40 is to perform clear coating with a silicate-based material on the hose clip after the desulfurization and dryness step S30.

Here, it is preferred that the composite coating film deposition-coating step S10 includes a first composite coating film deposition-coating step S10a and a second composite coating film deposition-coating step S10b, and the desulfurization step S20 includes a first desulfurization step S20a and a second desulfurization step S20b, and the desulfurization and dryness step S30 includes a first desulfurization and dryness step S30a and a second desulfurization and dryness step S30b, and the silicate-coating step S40 includes a first silicate-coating step S40a and a second silicate-coating step S40b.

Meanwhile, after the shot pinning step S14, the first composite coating film deposition-coating step S10a of performing deposition-coating with the composite coating film on the hose clip, and then the first desulfurization step S20a of performing desulfurization are performed, and after the first desulfurization step S20a, the second composite coating film deposition-coating step S10b of performing deposition-coating with a composite coating film again on the hose clip is performed, and after the second composite coating film deposition-coating step S10b, the first desulfurization and dryness step S30a of performing desulfurization and dryness is performed.

In addition, after the first desulfurization and dryness step S30a, the first silicate-coating step S40a of performing clear coating with a silicate-based material on the hose clip is performed, and after the first silicate-coating step S40a, the second desulfurization step S20b of performing desulfurization is performed, and after the second desulfurization step S20b, the second silicate-coating step S40b of performing clear coating with the silicate-based material on the hose clip again is performed, and after the second silicate-coating step S40b, the second desulfurization and dryness step S30b of performing desulfurization and dryness is performed.

Meanwhile, preferably, the composite coating films in the first composite coating film deposition-coating step S10a and the second composite coating film deposition-coating step S10b may be a zinc-aluminum composite coating film.

As described above, the manufacturing process of the hose clip according to the present disclosure may include the composite coating film deposition-coating step S10 of performing deposition-coating with a composite coating film on a hose clip; the desulfurization step S20 of performing desulfurization, after the composite coating film deposition-coating step S10; the desulfurization and dryness step S30 of performing desulfurization and dryness, after performing the desulfurization step S20 and deposition-coating again with a composite coating film on the hose clip; and the silicate-coating step S40 of performing clear coating with a silicate-based material on the hose clip, after the desulfurization and dryness step S30, so that the clear coating with a silicate-based material is performed on the hose clip, thereby preventing corrosion by potential difference, improving visibility as compared to the related art, such that phenomenon such as coolant leakage and engine burning due to fastening omission of the hose clip may be prevented to improve marketability and durability of a vehicle.

As described above, according to the exemplary embodiments of the present disclosure, a silicate inorganic binder and an acrylic inorganic binder are appropriately diluted in the hose clip to perform clear post-processing coating, thereby preventing corrosion by potential difference, improving visibility as compared to the related art, such that phenomenon such as coolant leakage and engine burning due to fastening omission of the hose clip may be prevented to improve marketability and durability of a vehicle.

Although the present disclosure has been described with reference to exemplary embodiments and the accompanying drawings, it would be appreciated by those skilled in the art that the present disclosure is not limited thereto but various modifications and alterations might be made without departing from the idea of the present disclosure and the scope defined in the claims.

What is claimed is:

1. A hose clip comprising:
a body made of a steel material; and
a composite coating film formed on a surface of the body,
wherein the composite coating film is clear post-processed with a silicate-based material to improve visibility and to secure corrosion resistance when coupling with a rubber hose.

2. The hose clip according to claim 1, wherein the silicate-based material includes a water-soluble inorganic main component of alkaline silicate.

3. The hose clip according to claim 2, wherein the body is post-processed with the water-soluble inorganic main component to prevent corrosion by potential difference of the rubber hose.

4. The hose clip according to claim 2, wherein the silicate-based material is stacked and coated at a thickness of 2 to 4 μm.

5. The hose clip according to claim 2, wherein the silicate-based material consists of a silicate inorganic binder in an amount of 70 to 80% and an acrylic inorganic binder in an amount of 20 to 30%.

6. A manufacturing process of a hose clip, comprising:
a composite coating film deposition-coating step of performing deposition-coating with a composite coating film on a hose clip;
a desulfurization step of performing desulfurization, after the composite coating film deposition-coating step;
a desulfurization and dryness step of performing desulfurization and dryness, after performing the desulfurization step and deposition-coating again with a composite coating film on the hose clip; and
a silicate-coating step of performing clear coating with a silicate-based material on the hose clip, after the desulfurization and dryness step.

7. The manufacturing process according to claim 6, further comprising:
a deposition-degreasing step of removing deposition on a surface of the hose clip;
a pickling treatment step of removing an oxide film on the surface of the hose clip after the deposition-degreasing step;
an electrolytic degreasing step of removing an oil membrane attached onto the surface of the hose clip by using gas generated in electrolysis after the pickling treatment step; and
a shot pinning step of spraying a shot on the surface of the hose clip to generate residual pressure stress on a surface layer and to intensify the hose clip by work hardening after the electrolytic degreasing step,
wherein after the shot pinning step, the composite coating film deposition-coating step is performed.

8. The manufacturing process according to claim 7, wherein:
the composite coating film deposition-coating step includes a first composite coating film deposition-coating step and a second composite coating film deposition-coating step, and the desulfurization step includes a first desulfurization step and a second desulfurization step, and the desulfurization and dryness step includes a first desulfurization and dryness step and a second desulfurization and dryness step, and the silicate-coating step includes a first silicate-coating step and a second silicate-coating step.

9. The manufacturing process according to claim 8, wherein:
after the shot pinning step, the first composite coating film deposition-coating step of performing deposition-coating with the composite coating film on the hose clip is performed,
after the first composite coating film deposition-coating step, desulfurization is performed by the first desulfurization step,
after the first desulfurization step, deposition-coating with a composite coating film on the hose clip is performed again by the second composite coating film deposition-coating step,
after the second composite coating film deposition-coating step, desulfurization and dryness are performed by the first desulfurization and dryness step,
after the first desulfurization and dryness step, clear coating with a silicate-based material on the hose clip is performed by the first silicate-coating step,
after the first silicate-coating step, desulfurization is performed by the second desulfurization step,
after the second desulfurization step, clear coating with a silicate-based material on the hose clip is performed again by the second silicate-coating step, and
after the second silicate-coating step, desulfurization and dryness are performed by the second desulfurization and dryness step.

10. The manufacturing process according to claim 9, wherein the composite coating films in the first composite coating film deposition-coating step and the second composite coating film deposition-coating step are a zinc-aluminum composite coating film.

11. A hose clip for coupling with a rubber hose, the hose clip comprising:
a body made of a steel material; and
a composite coating film coated on a surface of the body,
wherein the composite coating film comprises a silicate-based material.

12. The hose clip according to claim 11, wherein the silicate-based material includes a water-soluble inorganic main component of alkaline silicate.

13. The hose clip according to claim 11, wherein the silicate-based material is stacked and coated at a thickness of 2 to 4 μm.

14. The hose clip according to claim 11, wherein the silicate-based material consists of a silicate inorganic binder in an amount of 70 to 80% and an acrylic inorganic binder in an amount of 20 to 30%.

15. The hose clip according to claim 11, wherein a color of the hose clip is different from a color of the rubber hose.
